(19) United States
(12) Patent Application Publication
(10) Pub. No.: US 2011/0000839 A1
(43) Pub. Date: Jan. 6, 2011

(54) FILTER CARTRIDGE CENTERING DEVICE

(76) Inventor: Jimmie E. Dorman, Canadian, TX (US)

Correspondence Address: THOMPSON & THOMPSON, P.A., P.O BOX 166, SCANDIA, KS, 66966, US

(21) Appl. No.: 12/498,064

(22) Filed: Jul. 6, 2009

(51) Int. Cl. B01D 35/30

(52) U.S. Cl. 210/232

(57) ABSTRACT

A filter cartridge centering device and method are provided for centering a filter cartridge within a filter canister. The device includes a flexible elongate strap having a strap portion with a series of ratchet teeth formed near a first end and an enlarged head portion formed at a second end. The head portion contains an aperture and a pawl that cooperates with the ratchet teeth to prevent removal of the strap portion from the aperture. A plurality of flexible fingers extend generally perpendicularly from the strap portion at spaced locations along a length of the strap portion. The flexible fingers are arranged to extend radially outwardly from the filter cartridge to engage an inner wall of the filter canister to center the filter cartridge within the canister.

### BACKGROUND OF THE INVENTION

1. Field of the Invention

The present invention relates generally to devices for positioning a first object relative to a second object, and in particular, to a centering device for use in positioning a filter cartridge within a filter canister.

2. Description of the Related Art

Water purification systems are widely used to filter impurities from domestic water supplies. Various filtration elements are used in such systems, including reverse osmosis membranes, carbon adsorption filters, and the like. The filtration elements function to remove particulate matter and a range of dissolved solids and other contaminants to produce purified water. The filtration elements are typically provided in the form of replaceable filter cartridges that can be removed and replaced periodically to maintain the system.

A typical water purification system has at least one cylindrical-shaped filter cartridge mounted within a filter canister. The filter canister has female threads at its upper end for fastening to corresponding male threads on a housing of the system. The filter cartridge can be removed and replaced by unscrewing the filter canister from the housing, lifting the old filter cartridge from the canister, and placing a new filter cartridge back into the canister. However, it is often difficult to keep the new filter cartridge properly centered within the canister while the canister is being reattached to the housing.

There is a need for an improved device for positioning a filter cartridge within a filter canister when reattaching the filter canister to a water purification system.

### SUMMARY OF THE INVENTION

It is an object of the present invention to provide a centering device that can be quickly and easily attached to a filter cartridge to aid in the reassembly of water purification systems.

It is a further object of the present invention to provide a centering device for filter cartridges that is inexpensive to manufacture, simple to use, reliable in operation, and does not interfere with the normal operation of a water purification system.

To accomplish these and other objects of the present invention, a filter centering device and method are provided for centering a filter cartridge within a filter canister. The device includes a flexible elongate strap, similar in some respects to a conventional cable tie, that has a strap portion with a series of ratchet teeth formed near a first end and an enlarged head portion formed at a second end. The head portion contains an aperture and a pawl that cooperates with the ratchet teeth to allow the strap to be securely fastened to an outer circumference of a cylindrical-shaped filter cartridge. A plurality of flexible fingers extend generally perpendicularly from the strap portion at spaced locations along a length of the strap portion. The flexible fingers are arranged to extend radially outwardly from the filter cartridge to engage an inner wall of the filter canister to center the filter cartridge within the canister.

According to one aspect of the present invention, a filter cartridge centering device is provided, comprising: a flexible elongate strap and a plurality of flexible fingers extending generally perpendicularly from the strap. The strap portion has first and second ends, a series of ratchet teeth formed along the strap portion adjacent to the first end, and an enlarged head portion at the second end of the strap portion. The head portion contains an aperture and a pawl disposed within the aperture. The pawl and the ratchet teeth are complementary and oriented such that when the first end of the strap portion is inserted through the aperture the pawl and the ratchet teeth cooperate to prevent removal of the strap portion from the aperture. The flexible fingers are provided at spaced locations along the strap portion between the first and second ends. The flexible fingers are adapted to extend radially outwardly from the strap portion when the strap portion is arranged in a circular shape with the first end of the strap portion inserted through the aperture.

According to another aspect of the present invention, a method of centering a cylindrical filter cartridge within a filter canister when reassembling a filtration system is provided, comprising: installing a centering device around the filter cartridge, the centering device having a plurality of flexible fingers extending radially outwardly from the filter cartridge; and inserting the filter cartridge into a filter canister with the flexible fingers of the centering device engaging an inner surface of the filter canister to center the filter cartridge within the filter canister.

Numerous other objects of the present invention will be apparent to those skilled in this art from the following description wherein there is shown and described an example embodiment of the present invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings. In the drawings:

FIG. 1 is a plan view of a filter cartridge centering device according to the present invention.

FIG. 2 is a side view of the filter cartridge centering device shown in FIG. 1.

FIG. 3 is a side view of the filter cartridge centering device in an annular configuration with its first and second ends connected together.

FIG. 4 is a perspective view of the filter cartridge centering device shown in FIG. 3.

FIG. 5 is an end view of a filter cartridge centered within a filter canister by the centering device of the present invention.

FIG. 6 is a perspective view of the filter cartridge with the centering device installed thereon.

FIG. 7 is a perspective view of the filter cartridge centered within the filter canister by the centering device.

### DETAILED DESCRIPTION OF THE INVENTION

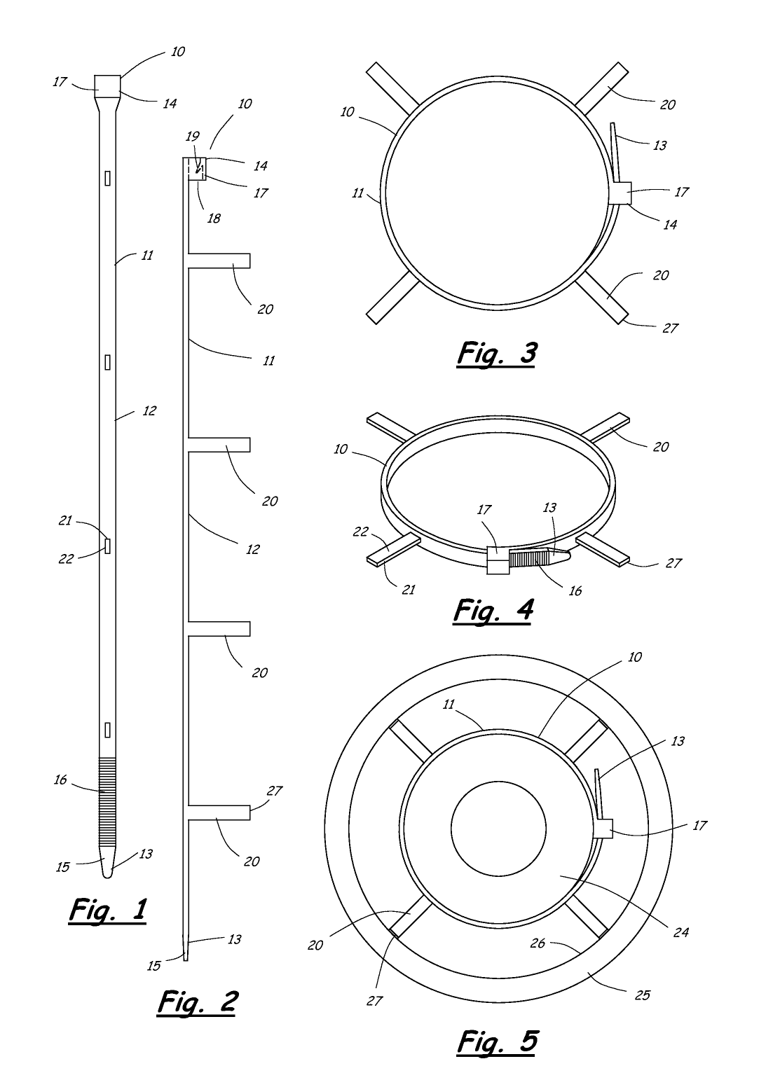

A filter cartridge centering device 10 according to the present invention will now be described in detail with reference to FIGS. 1 to 7 of the accompanying drawings.

The filter centering device 10 includes a flexible elongate strap 11 having a strap portion 12 with first and second ends 13, 14. A tapered tongue 15 is formed at the first end 13, and a series of ratchet teeth 16 are formed on a surface of the strap portion 12 adjacent to the tongue 15.

An enlarged head portion 17 is formed at the second end 14 of the strap portion 12 opposite from the tongue 15 and the ratchet teeth 16. The head portion 17 contains an aperture 18 and a pawl 19 disposed within the aperture 18. The pawl 19 and the ratchet teeth 16 are complementary and oriented such that when the first end 13 of the strap portion 12 is inserted through the aperture 18, the pawl 19 and ratchet teeth 16 cooperate to prevent removal of the strap portion 12 from the aperture 18. The structure of the pawl 19 and the ratchet teeth 16 can be, for example, the same structure used in conventional plastic cable ties.

As shown in FIGS. 3 and 4, the first end 13 of the strap portion 12 can be inserted through the aperture 18 of the head portion 17 to form an annular configuration. The head portion 17 is arranged with the aperture 18 generally parallel to a longitudinal direction of the strap 11. That is, the aperture 18 is arranged so that the first and second ends 13, 14 of the strap portion 12 are generally parallel with each other where the ends 13, 14 overlap immediately adjacent to the head portion 17. This allows the first end 13 of the strap portion 12 to be inserted into the aperture 18 without requiring the second end 14 of the strap portion 12 to be bent away from a continuous circular shape.

A plurality of flexible fingers 20 extend generally perpendicularly from the strap portion 12 at spaced locations between the first and second ends 13, 14. The flexible fingers 20 are molded plastic structures that are formed integral with the strap portion 12. In a preferred embodiment, the strap portion 12, head portion 17, and flexible fingers 20 will all be formed integral with each other using an injection molding process or other suitable manufacturing process.

The flexible fingers 20 have more flexibility in a direction perpendicular to the strap portion 12 than in a direction parallel to the strap portion 12. This is accomplished by the flexible members 20 having a relatively thin dimension 21 in a direction perpendicular to the strap portion 12, and a relatively thick dimension 22 in a direction parallel to the strap portion 12. In the preferred embodiment, at least three, and preferably at least four, flexible fingers 20 are provided on the strap portion 12 at spaced locations between the first and second ends 13, 14.

In its annular configuration, the flexible elongate strap 11 can be positioned on the outer surface 23 of a cylindrical filter cartridge 24 and tightened to secure the strap 11 to the cartridge 24 with the flexible fingers 20 extending radially outwardly therefrom. The strap 11 is tightened about the cartridge 24 by sliding the first end 13 of the strap portion 12 through the head portion 17. The pawl 19 and ratchet teeth 16 allow the strap portion 12 to be slid in one direction through the head portion 17 to reduce the diameter of the circular configuration, while preventing sliding movement in the other direction. The pawl 19 and ratchet teeth 16 cooperate to maintain the strap 11 in a tightened condition on the filter cartridge 24.

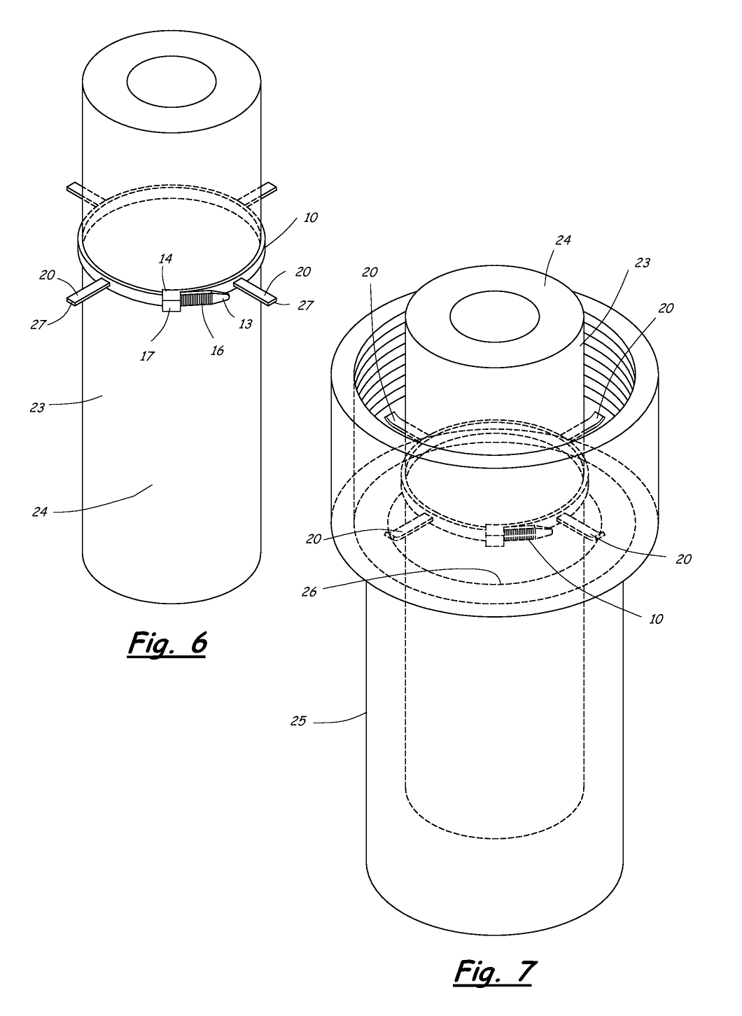

Once the centering device 10 is installed on the filter cartridge 24, as shown in FIG. 6, the filter cartridge 24 can be inserted into a filter canister 25, as shown in FIGS. 5 and 7. The flexible fingers 20 are arranged to engage an inner surface 26 of the filter canister 25 to center the filter cartridge 24 within the canister 25. The flexible fingers 20 have outer tips 27 that engage the inner surface 26 of the filter canister 25 and cause the flexible fingers 20 to flex in a direction parallel to a direction of insertion of the filter cartridge 24 into the filter canister 25. The flexible fingers 20 provide centering forces that push against the inner surface 26 of the filter canister 25 to maintain the filter cartridge 24 properly positioned within the canister 25.

The centering device 10 is adjustable to fit various sizes of filter cartridges 24. A first adjustment can be made by simply sliding the first end 13 of the strap portion 11 through the head portion 17 until the device 10 fits tight to the outer surface 23 of the filter cartridge 24. For larger filter cartridges, two or more straps 11 can be attached together end-to-end to form a long combined strap assembly. The combined strap assembly can then be adjusted to fit tight to the outer surface of the larger filter cartridge.

In some cases, it will be advantageous to use two or more centering devices 10 on a single filter cartridge 24. For example, the centering devices 10 can be spaced from each other in a longitudinal direction to support the filter cartridge at spaced locations along its length. For another example, two or more centering devices 10 can be secured to the filter cartridge 24 next to each other, but circumferentially offset, so that the flexible fingers 20 of each centering device 10 are circumferentially spaced from each other.

The centering device 10 and method of the present invention eliminates the common difficulty of maintaining a proper position of a filter cartridge 24 within a filter canister 25 as the filter assembly is reassembled during routine maintenance and filter cartridge replacement.

While the invention has been specifically described in connection with specific embodiments thereof, it is to be understood that this is by way of illustration and not of limitation, and the scope of the appended claims should be construed as broadly as the prior art will permit.

What is claimed is:

1. A filter cartridge centering device comprising:
a flexible elongate strap having a strap portion with first and second ends, a series of ratchet teeth formed along said strap portion adjacent to said first end, and an enlarged head portion at said second end of said strap portion, said head portion containing an aperture and a pawl disposed within said aperture, said pawl and said ratchet teeth being complementary and so oriented that when the first end of the strap portion is inserted through the aperture the pawl and ratchet teeth cooperate to prevent removal of the strap portion from the aperture; and
a plurality of flexible fingers extending generally perpendicularly from said strap portion at spaced locations along said strap portion between said first and second ends, said flexible fingers being adapted to extend radially outwardly from said strap portion when said strap portion is arranged in a circular shape with the first end of the strap portion inserted through the aperture.

2. The filter cartridge centering device according to claim 1, wherein said flexible elongate strap is adapted to be tightened about an outer surface of a cylindrical filter cartridge with said flexible fingers extending radially outwardly from said strap portion.

3. The filter cartridge centering device according to claim 2, wherein said flexible fingers are adapted to engage an inner wall of a filter canister for centering the filter cartridge within the canister.

4. The filter cartridge centering device according to claim 1, wherein said flexible fingers are molded plastic structures formed integral with said strap portion.

5. The filter cartridge centering device according to claim 1, wherein said flexible fingers are arranged so that they have more flexibility in a direction perpendicular to said strap than in a direction parallel to said strap.

6. The filter cartridge centering device according to claim 5, wherein said flexible fingers have a relatively thin dimension perpendicular to said strap and a relatively thick dimension parallel to said strap.

7. The filter cartridge centering device according to claim 1, wherein said aperture in said head portion is generally parallel to a longitudinal direction of said strap to allow the first end of said strap portion to be inserted into said aperture without bending said second end of said strap portion away from a continuous circular shape.

8. The filter cartridge centering device according to claim 1, wherein said plurality of flexible fingers comprises at least four flexible fingers extending from said strap portion at spaced locations between said first and second ends.

9. In combination, a cylindrical-shaped filter cartridge and a centering device for centering the filter cartridge within a filter canister, the centering device comprising:
a flexible elongate strap having a strap portion with first and second ends, a series of ratchet teeth formed along said strap portion adjacent to said first end, and an enlarged head portion at said second end of said strap portion, said head portion containing an aperture and a pawl disposed within said aperture, said pawl and said ratchet teeth being complementary and so oriented that when the first end of the strap portion is inserted through the aperture the pawl and ratchet teeth cooperate to prevent removal of the strap portion from the aperture; and
a plurality of flexible fingers extending generally perpendicularly from said strap portion at spaced locations along said strap portion between said first and second ends, said flexible fingers being adapted to extend radially outwardly from said strap portion when said strap portion is arranged about an outer surface of the cylindrical filter cartridge, whereby said flexible fingers are adapted to engage an inner wall of the filter canister to center the filter cartridge within the canister.

10. The combination according to claim 9, wherein said flexible fingers are molded plastic structures formed integral with said strap portion.

11. The combination according to claim 9, wherein said flexible fingers have more flexibility in a direction perpendicular to said strap than in a direction parallel to said strap.

12. The combination according to claim 9, wherein said flexible fingers have outer tips that engage an inner surface of the filter canister and cause the flexible fingers to flex in a direction perpendicular to said strap as the filter cartridge is inserted into the filter canister.

13. The combination according to claim 9, wherein said flexible fingers have a relatively thin dimension perpendicular to said strap and a relatively thick dimension parallel to said strap.

14. The combination according to claim 9, wherein said aperture in said head portion is generally parallel to a longitudinal direction of said strap to allow the first end of said strap portion to be inserted into said aperture without bending said second end of said strap portion away from a continuous circular shape.

15. The combination according to claim 9, wherein said plurality of flexible fingers comprises at least four flexible plastic fingers extending from said strap portion at spaced locations between said first and second ends.

16. A method of centering a cylindrical filter cartridge within a filter canister when reassembling a filtration system, comprising:
installing a centering device around said filter cartridge, said centering device having a plurality of flexible fingers extending radially outwardly from said filter cartridge; and
inserting said filter cartridge into a filter canister with the flexible fingers of said centering device engaging an inner surface of the filter canister to center the filter cartridge within the filter canister.

17. The method according to claim 16, wherein said centering device further comprises:
a flexible elongate strap having a strap portion with first and second ends, a series of ratchet teeth formed along said strap portion adjacent to said first end, and an enlarged head portion at said second end of said strap portion, said head portion containing an aperture and a pawl disposed within said aperture, said pawl and said ratchet teeth being complementary and so oriented that when the first end of the strap portion is inserted through the aperture the pawl and ratchet teeth cooperate to prevent removal of the strap portion from the aperture; and
said plurality of flexible fingers extend generally perpendicularly from said strap portion at spaced locations along said strap portion between said first and second ends.

18. The method according to claim 16, wherein said flexible fingers of said centering device have outer tips that engage the inner surface of the filter canister and cause the flexible fingers to flex in a direction parallel to a direction of insertion of the filter cartridge into the filter canister.

19. The method according to claim 16, wherein said plurality of flexible fingers comprises at least four flexible plastic fingers extending from a flexible elongate strap at spaced locations along said strap.
